(19) United States
(12) Patent Application Publication
(10) Pub. No.: US 2024/0180211 A1
(43) Pub. Date: Jun. 6, 2024

(54) YOUNG BARLEY GRASS POWDER AND GRANULATED PRODUCT COMPRISING YOUNG BARLEY GRASS POWDER

(71) Applicant: TOYO SHINYAKU CO., LTD., Fukuoka (JP)

(72) Inventors: Hiroya TAKAHASHI, Saga (JP); Yoshifumi KOSEKI, Saga (JP)

(73) Assignee: TOYO SHINYAKU CO., LTD., Fukuoka (JP)

(21) Appl. No.: 18/466,314

(22) Filed: Sep. 13, 2023

(30) Foreign Application Priority Data
Dec. 6, 2022 (JP) 2022-194796

(51) Int. Cl. A23L 7/10

(52) U.S. Cl. CPC A23L 7/198

(57) ABSTRACT

The present inventors made a keen study on foods having an effect of intestinal regulation, and/or effect of improving maintenance of immune function, and found out that young barley grass powder exerts an excellent effect of intestinal regulation, and/or effect of improving maintenance of immune function, and that by adjusting the particle diameter of young barley grass powder at a prescribed size, a further excellent effect of intestinal regulation, and/or effect of improving maintenance of immune function is exerted. Thus, the present invention has been completed. Further, the present inventors made a keen study on foods having an effect of intestinal regulation, and/or effect of improving maintenance of immune function, and found out that when the hemicellulose content in young barley grass powder is within a prescribed range, a further excellent effect of intestinal regulation, and/or effect of improving maintenance of immune function is exerted.

A Sequence Listing in XML file format was filed via the USPTO patent electronic filing system with this application on Sep. 13, 2023, and is incorporated herein by reference. The name of the file is “P69660_Sequence_Listing. XML”; the file was created on Sep. 13, 2023; and the size of the file is 10, 555 bytes.

### CROSS-REFERENCE TO RELATED APPLICATIONS

This application claims benefit of Japanese Application No. 2022-194796 filed in Japan on Dec. 6, 2022, the contents of which are incorporated by this reference.

### BACKGROUND OF THE INVENTION

### Field of the Invention

The present invention relates to young barley grass powder and a granulated product comprising young barley grass powder.

Recently, due to the influence of change in eating habits, biased content of meals, stress, etc., various lifestyle-related diseases are widely spread. As one of symptoms caused by lifestyle habits, malfunction of intestine such as constipation and diarrhea is known. Particularly, constipation may induce various problems such as abdominal pain, headache, and damaged skin, and may also become cause of bowel cancer. Thus, aiming to ameliorate malfunction of intestine such as constipation, development of foods regulating intestinal function is promoted.

As foods regulating intestinal function, for example composition regulating intestinal function comprising bacteria of a genus Lactococcus is known (patent reference 1). However, foods having been developed so far did not necessarily have sufficient effect of regulating intestinal function, and new foods regulating intestinal function were awaited.

### PRIOR ART DOCUMENTS

[Patent Reference 1] US Publication No. 2010/0086988

### SUMMARY OF THE INVENTION

### Technical Problem

The object of the present invention is to provide young barley grass powder exerting an effect of intestinal regulation, and/or effect of improving maintenance of immune function, and a granulated product comprising the same.

### Solution to Problem

The present inventors made a keen study on foods having an effect of intestinal regulation, and/or effect of improving maintenance of immune function, and found out that young barley grass powder exerts an excellent effect of intestinal regulation, and/or effect of improving maintenance of immune function, and further that by adjusting the particle diameter of young barley grass powder at a prescribed size, a further excellent effect of intestinal regulation, and/or effect of improving maintenance of immune function is exerted. Thus, the present invention has been completed.

Further, the present inventors made a keen study on foods having an effect of intestinal regulation, and/or effect of improving maintenance of immune function, and found out that when the hemicellulose content in young barley grass powder is within a prescribed range, a further excellent effect of intestinal regulation, and/or effect of improving maintenance of immune function is exerted. Thus, the present invention has been completed.

Specifically, the present invention is as follows.
[1] A young barley grass powder having a median diameter of 100 μm or less.
[2] The young barley grass powder according to [1], wherein a hemicellulose content in the young barley grass powder is 5 to 30% by weight.
[3] The young barley grass powder according to [1], wherein a hemicellulose content in the young barley grass powder is 10 to 20% by weight.
[4] A food or beverage comprising the young barley grass powder according to [1].
[5] A granulated product comprising the young barley grass powder according to [1].
[6] The granulated product according to [5], wherein the granulated product is for beverage.
[7] A food or beverage comprising the granulated product according to [5].
[8] A method for producing a granulated product, comprising a step of granulating young barley grass powder having a median diameter of 100 μm or less by a fluidized-bed granulation.
[9] A young barley grass powder, wherein the hemicellulose content in the young barley grass powder is 5 to 30% by weight.
[10] A young barley grass powder, wherein the hemicellulose content in the young barley grass powder is 10 to 20% by weight.
[11] A method for maintaining or improving intestinal regulation, comprising administering a composition comprising young barley grass to human.
[12] A method for ameliorating bowel movement, comprising administering a composition comprising young barley grass to human.
[13] A method for ameliorating intestinal environment, comprising administering a composition comprising young barley grass to human.
[14] A method for proliferating intestinal lactic acid bacteria, comprising administering a composition comprising young barley grass to human.
[15] A method for proliferating intestinal butyric acid bacteria, comprising administering a composition comprising young barley grass to human.
[16] A method for maintaining or improving immunity, comprising administering a composition comprising young barley grass to human.
[17] A method for promoting IgA secretion, comprising administering a composition comprising young barley grass to human.
[18] The method according to any one of to [17], wherein a median diameter of young barley grass powder is 100 μm or less.
[19] The method according to any one of to [17], wherein a hemicellulose content in the young barley grass powder is 5 to 30% by weight.

### Advantageous Effects of Invention

Young barley grass powder and a granulated product comprising the same of the present invention exert an excellent effect of intestinal regulation, and/or effect of improving maintenance of immune function. Further, by adjusting the particle diameter of young barley grass powder at a prescribed size, young barley grass powder and the granulated product comprising the same of the present invention exert a further excellent effect of intestinal regulation, and/or effect of improving maintenance of immune function. Further, when the hemicellulose content in young barley grass powder is within a prescribed range, young barley grass powder and the granulated product comprising the same of the present invention exert a further excellent effect of intestinal regulation and/or effect of improving maintenance of immune function.

### DESCRIPTION OF EMBODIMENTS

The present invention is explained in detail in the following.

### [A. Young Barley Grass Powder]

Barley (Hordeum vulgare L.) is said to be native of Central Asia, is a poaceous annual or biennial grass plant belonging to Granmineae. As barley used in the present invention, breed is not particularly limited. Barley of any breed can be used, and even wild species or crossbred can be used.

Young barley grass of the present invention relates to plant body of barley including leaf part, and can include leaves, as well as stem, or other parts. From the viewpoint of exerting further significant effect of intestinal regulation, it is preferable to comprise only leaves, or stem together with leaves.

As young barley grass, it can be any one harvested at any harvest season, and it is not particularly limited. However, from the viewpoint of exerting further significant effect of intestinal regulation, it is preferable to use those harvested before mature stage, specifically those from harvested initiation of tillering stage to before initiation of ear emergence. Specifically, it is preferable to use young barley grass harvested from barley having a height of 10 cm or more, preferably about 10 to 90 cm, particularly preferably about 20 to 80 cm, best of all about 30 to 70 cm.

Young barley grass powder of the present invention relates to young barley grass that has been powderized. As young barley grass powder of the present invention, examples include crushed powder of young barley grass, dry powder of young barley grass juice, dry powder of young barley grass extract, etc. From the viewpoint of exerting further significant effect of intestinal regulation, and/or effect of improving maintenance of immune function, it is preferable to use crushed powder of young barley grass.

Crushed powder of young barley grass of the present invention can be obtained for example by combining drying treatment and crushing treatment. Drying treatment and crushing treatment can be performed at the same time, or either one can be performed before the other one. However, it is preferable to first perform drying treatment, and then perform crushing treatment. For drying and powderizing young barley grass, further according to need, one or more treatments selected from treatment such as blanching treatment and disinfection treatment can be performed in combination. The number of times for performing crushing treatment is not particularly limited, and it can be performed as one or more treatments, such as after performing coarse crushing treatment, performing fine crushing for crushing more finely.

Blanching treatment is a treatment to keep the green color of young barley grass bright, and examples of a method of blanching treatment include hot-water treatment and steaming treatment.

Examples of hot-water treatment include a method of treating young barley grass in hot water or moisture of for example 70 to 100° C., preferably 80 to 100° C., for 60 to 240 sec, preferably for 90 to 180 sec.

As steaming treatment, an intermittent steaming treatment of repeating a treatment of steaming young barley grass with moisture and a treatment of cooling at normal pressure or under pressure is preferable. In an intermittent steaming, treatment of steaming with moisture is performed for example for 20 to 40 sec, preferably 30 sec. Cooling treatment after steaming treatment is preferably performed immediately, and the method is not particularly limited.

Disinfection treatment is not particularly limited as long as it is a disinfection treatment commonly known to a person skilled in the art. For example, it can be a treatment of killing microorganisms physically or chemically by using temperature, pressure, electromagnetic wave, drugs, etc.

When performing blanching treatment additionally to drying treatment and crushing treatment, it is preferable that blanching treatment is performed before drying treatment. Further, when performing disinfection treatment additionally to drying treatment and crushing treatment, it is preferable that disinfection treatment is performed after drying treatment, or before or after crushing treatment.

Drying treatment is not particularly limited, but examples include treatment of drying so that the water content of young barley grass becomes 10% by weight or less, preferably 8% by weight or less. Drying treatment can be performed by an arbitrary method known to a person skilled in the art, for example air hot drying, high-pressure steam drying, electromagnetic wave drying, lyophilization, etc.

Crushing treatment is not particularly limited, but examples include treatment of crushing plant bodies by an arbitrary method that a person skilled in the art commonly uses. When performing crushing treatment, it is preferable to perform the treatment by combining coarse crushing and fine crushing, from the viewpoint of increasing crushing efficiency, such as to make the particle size uniform, shortening the crushing time, etc.

In crushing treatment, during coarse crushing process, young barley grass is crushed using an arbitrary equipment or device for coarse crushing that a person skilled in the art commonly uses such as cutter, slicer, dicer, etc. so that the longest diameter of young barley grass becomes about 20 mm or less, preferably about 0.1 to 10 mm. During fine crushing process, young barley grass is finely crushed using an arbitrary equipment or device for fine crushing that a person skilled in the art commonly uses such as crusher, mill, blender, millstone, etc. By appropriately setting the conditions of crushing treatment based on a method that a person skilled in the art commonly uses, physical properties such as median diameter of young barley grass powder can be adjusted.

Dry powder of young barley grass juice of the present invention can be obtained by a method of powderizing juice extract of young barley grass. Specifically, it can be obtained by extracting juice by mechanical crushing means such as mixer, juicer, etc. and by removing rough solid parts by sieving, filtration, etc. according to need, and then by powderizing by spray drying, freeze drying, etc. When powderizing, excipient can be added according to need.

Dry powder of young barley grass extract of the present invention can be obtained for example by a method of powderizing extract liquid of young barley grass. Specifically, it can be obtained by adding extraction solvent such as ethanol, water, water containing-ethanol, etc. to fine fragments of young barley grass, obtaining extraction liquid by stirring or heating according to need, and then by powderizing by spray drying, freeze drying, etc. When powderizing, excipient can be added according to need.

### [B. Median Diameter of Young Barley Grass Powder]

Young barley grass powder of the present invention is characterized by having a median diameter of 100 μm or less. Median diameter is the particle size being 50% cumulative (volume) of particle size distribution of the powder. With a median diameter of 100 μm or less, since the fecal wet weight and useful intestinal bacteria are increased, an excellent effect of intestinal regulation, and/or effect of improving maintenance of immune function is exerted. The median diameter of young barley grass powder is not particularly limited as long as it is 100 μm or less. However, from the viewpoint of exerting more significantly the effect of intestinal regulation, and/or effect of improving maintenance of immune function, it is preferably 80 μm or less, and the median diameter of young barley grass powder is more preferably 50 μm or less, further preferably 30 μm or less, furthermore preferably 25 μm or less, best of all 23 μm or less, particularly preferably 20 μm or less, and most preferably 19 μm or less. The lower limit of median diameter of young barley grass powder is not particularly limited, but from the viewpoint of easiness of production, it is preferably 5 μm or more, more preferably 7 μm or more, and particularly preferably 10 μm or more. For the measurement of median diameter of young barley grass powder, for example, laser scattering particle size distribution analyzer, specifically LMS-300 or LMS-3000 manufactured by Seishin Enterprise Co., Ltd. can be used. As dispersion medium used when measuring median diameter, a medium in which young barley grass powder does not swell can be appropriately selected, but when young barley grass powder is young barley grass powder crushed powder, ethanol shall be used as dispersion medium.

Young barley grass powder having a median diameter of 100 μm or less can be obtained, for example by appropriately adjusting conditions of crushing treatment in the crushing process of young barley grass, or by appropriately adjusting conditions of powderizing treatment in the production of dry powder of juice, dry powder of extract. It is the same when it is intended to make the median diameter smaller.

### [C. Hemicellulose in Young Barley Grass Powder]

The young barley grass powder of the present invention may comprise hemicellulose. Hemicellulose relates to non-cellulose polysaccharide quantified as hemicellulose by Southgate method.

Hemicellulose can be quantified for example by Southgate method. Southgate method a method of analysis of fractionating dietary fiber by constituent sugar for quantification. It is a method of fractionating starch in the sample after enzyme treatment, into hemicellulose fractions, cellulose fractions, and lignin fractions, according to solubility to sulfuric acid at each concentration, to quantify constituent sugar of each fraction. Specifically, by performing enzyme deletion of starch from a composition, adding 5% sulfuric acid, heating (100° C., 2.5 hours) with reflux condenser, and after making a constant volume of the obtained soluble fractions, quantifying glucose by phenol-sulfuric acid method, and multiplying the coefficient 0.9, hemicellulose can be quantified.

The lower limit of hemicellulose content in the young barley grass powder is not particularly limited. However, from the viewpoint of exerting further significant effect of intestinal regulation, it can be 5% by weight or more, preferably 8% by weight or more, more preferably 10% by weight or more, further preferably 13% by weight or more, particularly preferably 15% by weight or more, and most preferably 16% by weight or more. The upper limit of hemicellulose content in the young barley grass powder is not particularly limited. However, from the viewpoint of exerting further significant effect of intestinal regulation, it can be 30% by weight or less, preferably 28% by weight or less, more preferably 25% by weight or less, further preferably 22% by weight or less, particularly preferably 20% by weight or less, and most preferably 19.5% by weight or less.

### [D. Food or Beverage Comprising Young Barley Grass Powder]

One embodiment of the present invention is food or beverage comprising young barley grass powder (hereinafter also referred to as “food or beverage of the present invention”). The food or beverage of the present invention can be only young barley grass powder, or it can comprise other food materials that are commonly used, other than young barley grass powder. As such materials, various excipients, binding agents, brightening agents, lubricants, stabilizing agents, diluents, bulking agents, thickening agents, emulsifying agents, antioxidizing agents, pH adjusters, coloring agents, fragrance, additives, etc. can be suitably selected.

As forms of food of the present invention, for example, tablet form, capsule form, powder form, granule form, liquid form, paste form, stick form, etc. can be exemplified. Among these dosage forms, from the viewpoint of producibility and ease of intake, powder form, granule form, and tablet form are particularly preferable. Granules relate to granulated products. When the form of food of the present invention is powder form or granule form, it has excellent characteristics such as having good fluidity, or it can be easily filled into sachets. Specific examples of food of the present invention include for example, tablet, soft capsule, hard capsule, etc. comprising young barley grass powder.

As forms of beverage of the present invention, beverage in liquid form or powder beverage can be exemplified. Powder beverage relates to processed foods supplied for drink, by being mixed in liquid such as water or hot water, milk, soy milk, etc. The form of beverage of the present invention can be any form, but since young barley grass powder of the present invention has a characteristic of being easily dispersed when suspended in water, it is particularly preferable to be in form of powder beverage. The form of powder beverage is also preferable in the point of having light weight, can be easily carried, and easily preserved. Specific examples of beverage of the present invention include for example, green juice, vegetable juice, smoothie, powder beverage made by powderizing these beverages, or the like.

The food or beverage of the present invention can be, as stated above, only young barley grass powder, or it can comprise other food materials that are commonly used, other than young barley grass powder. When food or beverage of the present invention comprises food materials other than young barley grass powder, the content of young barley grass powder in the food or beverage is not particularly limited. However, from the viewpoint of further significantly exerting an effect of intestinal regulation, and/or effect of improving maintenance of immune function, for example, in dry mass equivalent of the entire food or beverage, it is preferably 0.1% by weight or more, more preferably 0.5% by weight or more, further preferably 1% by weight or more, furthermore preferably 10% by weight or more, and particularly preferably 20% by weight or more.

In the food or beverage of the present invention, the amount of intake per day of young barley grass powder is not particularly limited, and for example, it can be 0.01 to 100 g, preferably 0.05 to 70 g, more preferably 0.5 to 50 g and further preferably 1 to 30 g. Similarly, in the food or beverage of the present invention, the amount of intake per dose of young barley grass powder is not particularly limited, and for example, it can be 0.01 to 30 g, preferably 0.05 to 20 g, more preferably 0.1 to 10 g, and further preferably 0.3 to 7 g.

### [E. Granulated Product Comprising Young Barley Grass Powder]

It is particularly preferable to use young barley grass powder of the present invention as a granulated product. Young barley grass powder that has been granulated has improved dispersibility in liquid and drinkability, and thus is suitable for use as powder beverage, and can be used as granulated product for beverage. Granulated product for beverage relates to a granulated product supplied for drink as beverage, by being mixed in liquid such as water or hot water, milk, soy milk, etc. by a consumer at the time of intake (powder beverage being a granulated product).

Granulation means an operation of agglomerating plural particles, to form an aggregate. In the aggregate (granulated product), a void is formed between particles when particles agglomerate, and there is a structural difference between granulated product and particles of raw materials used for granulation. Granulated products can be further mixed with raw materials other than green leaves of specific plant such as excipient and sweetener. The granulated product of the present invention is not particularly as long it is an agglomerate in which plural particles are agglomerated by some method, and the size of granulated product is not particularly limited.

As for granulation method of the present invention, it is not particularly limited and a granulation method that a person skilled in the art commonly uses should be appropriately selected. For example, fluidized-bed granulation, extrusion granulation, tumbling granulation, and stirring granulation, can be exemplified. With any granulation method, granulated products can be produced by using an arbitrary granulation apparatus available in the market, and by appropriately setting various production conditions such as drying temperature, etc. From the viewpoint of easiness of granulation, and obtaining granulated product having excellent dispersibility, fluidized-bed granulation is particularly preferable. Fluidized-bed granulation is a method of applying air to powder particles being the raw material to fluidize by aerial flow, while spraying coupling liquid such as water to attach powder particles to each other, to form a granulated product being agglomerate of powder particles.

When using young barley grass powder of the present invention as a granulated product, the content of young barley grass powder in the granulated product is not particularly limited. However, from the viewpoint that young barley grass powder can be efficiently intake, it is preferable that the content of young barley grass powder is high, and for example, as dry weight, it is preferable to be 10% by weight or more, more preferably 50% by weight or more, further preferably 80% by weight or more, particularly preferably 90% by weight or more, and most preferably 100% by weight.

### [F. Composition for Intestinal Regulation]

Since young barley grass powder and a granulated product comprising young barley grass powder of the present invention exert an excellent effect of intestinal regulation, it can be used as a composition for intestinal regulation. When using as a composition for intestinal regulation, it is not particularly limited as long as it can be distinguished from other products as product as being used for intestinal regulation. For example, those with an indication of having an effect of intestinal regulation on any of the main body, package, instructions, advertisement of the product of the present invention are encompassed in the present invention. The composition for intestinal regulation of the present invention is not limited to those with an indication of comprising young barley grass powder as active ingredients for intestinal regulation on the package of the product, etc. For example, it can be one indicating a particular ingredient (dietary fiber, etc.) contained in young barley grass powder as active ingredient, and it can be also one not specifying the active ingredients.

Intestinal regulation in the present invention means an action of adjusting the stomach condition. Action of adjusting the stomach condition is a concept encompassing action of ameliorating bowel or movement, action of ameliorating intestinal environment. Action of ameliorating bowel movement, is for example, in a subject having tendency toward constipation, an action of increasing frequency or amount of bowel motion, or action of abdominal alleviating pain associated with constipation, action of ameliorating odor of feces or condition of feces, etc.; and in a subject having tendency toward diarrhea, an action of decreasing frequency or level of diarrhea, action of ameliorating abdominal pain associated with diarrhea, and action of ameliorating odor of feces or condition of feces, etc. Action of ameliorating intestinal environment is for example, an action of keeping intestinal flora in good state, or an action of increasing beneficial bacteria or decreasing bad bacteria in the intestines. Therefore, the composition for intestinal regulation of the present invention is useful as composition for ameliorating bowel movement, or composition for ameliorating intestinal environment.

The composition for intestinal regulation of the present invention can be specifically exemplified by those indicating “ameliorating bowel movement”, “ameliorating feces”, “increasing stool frequency, stool amount”, “increasing number of times or amount of feces”, “ameliorating habitude of bowel motion”, “adjusting stool condition (color, odor, amount, form of stool)”, “alleviating abdominal symptoms”, “to those having tendency toward constipation”, “to those who want to adjust stomach condition”, “to those who are aware of stomach condition”, “to those suffering of stomach condition”, “ameliorating intestinal environment”, “ameliorating intestinal environment of large intestine”, “improving intestinal environment”, “improving intestinal flora”, “adjusting intestinal condition”, “increasing bifidobacteria”, “increasing beneficial bacteria”, etc. on any of the main body, package, instructions, or website of product sales of the product.

The composition for intestinal regulation of the present invention exerts an effect of ameliorating bowl motion by increasing fecal wet weight for making egestion to be smooth, as shown in the following Examples.

Further, the composition for intestinal regulation of the present invention exerts an action of ameliorating intestinal environment by increasing the number of bacteria such as lactic bacteria and butyric acid bacteria being useful intestinal bacteria, as shown in the following Examples. Therefore, the composition for intestinal regulation of the present invention is useful as composition for proliferating lactic bacteria or composition for proliferating butyric acid bacteria. Examples of lactic acid bacteria include bacteria belonging to the genus Lactobacillus, and examples of butyric acid bacteria include bacteria belonging to the genus Clostridium cluster XIVa.

### [G. Composition for Maintaining or Improving Immunity]

Since young barley grass powder and the food or beverage comprising young barley grass powder of the present invention exert an excellent effect of maintaining or improving immunity, it can be used as a composition for maintaining or improving immunity. The composition for maintaining or improving immunity of the present invention increases IgA amount in the gut tract, as shown in the following Examples. Since IgA has an action of preventing infection from bacteria or virus, by the increase of IgA, an effect of maintaining and improving immunity of gut tract is exerted. The composition for maintaining or improving immunity of the present invention is useful as a composition for promoting IgA secretion.

### Examples

In the following, the present invention is further explained with the Examples. However, the present invention is not limited to these Examples, and as long as the object of the invention can be solved, the present invention can have various embodiments.

### 1. Validation of Effects Caused by the Difference of Median Diameter

The influence of difference of median diameter of young barley grass powder on the effect of intestinal regulation and effect of improving maintenance of immune function was assessed by performing the tests described in the following.

### [1-1. Preparation of Young Barley Grass Powder]

Young barley grass comprising young leaves and stem being aerial part of barley harvested at a height of about 30 cm was washed with water to remove attached soil, and were cut to a size of about 5 to 10 cm. Pretreated young barley grass was subjected to blanching treatment with boiling water of 90 to 100° C. for 90 sec to 120 sec only once, and then cooled down with cold water. Then, the obtained young barley grass was dried in a drier for 20 min to 180 min, with hot air of 80° ° C. to 130° C. until the water content becomes 5% by weight or less. Dried young barley grass was subjected to coarse crushing treatment to a size of about 1 mm using a mixer. With the obtained young barley grass, using a small flour mill machine (product name: “micro powder KGW-G015”; manufactured by West), by adjusting the particle size adjusting dial of the flour mill machine 3 types of young barley grass powder having different median diameters were produced. The produced young barley grass powders are referred to as “young barley grass powder 1”, “young barley grass powder 2”, and “young barley grass powder 3”, respectively.

### [1-2. Measurement of Median Diameter]

The median diameter and average particle diameter of the obtained young barley grass powder were measured by using laser scattering particle size distribution analyzer (LMS-300; manufactured by Seishin Enterprise Co., Ltd.). Measurement conditions were: dispersion medium: ethanol, refraction index: 1.330-0.001; shape coefficient: 1.000. The measurement results are shown in Table 1.

TABLE 1

| | Young barley | Young barley | Young barley |
|---|---|---|---|
| | grass powder 1 | grass powder 2 | grass powder 3 |
| Median diameter (μm) | 14.91 | 23.75 | 41.85 |
| Average median | 13.28 | 18.40 | 29.96 |
| diameter (μm) | | | |

### [1-3. Preparation of Test Substance]

Each obtained young barley grass powder was mixed with AlN-76 refined feed (Table 2) to prepare test substances shown in the following Table 3. Those not added with young barley grass powder, specifically test substance with only AlN-76 refined feed was used as control group. AlN-76 refined feed was prepared by using mortar, muddler, and feeding machine (MT-30H; AICOH MIXERS & AICOH SYSTEMS). Mixing of young barley grass powder and AlN-76 refined feed was made by using a mortar and a muddler, to make a mixed feed, in which each ingredient is uniform.

TABLE 2

| | Composition (% by weight) |
|---|---|
| Milk casein | 20 |
| DL-methionine | 0.3 |
| Corn starch | 15 |
| Sucrose | 50 |
| Corn oil | 5 |
| Vitamin mixed (AIN-76) | 1 |
| Mineral mixed (AIN-76) | 3.5 |
| Choline bitartrate | 0.2 |
| Cellulose | 5 |
| Total | 100 |

TABLE 3

| Test substance | Control group | Example 1 | Example 2 | Example 3 |
|---|---|---|---|---|
| ANI-76 refined feed | 100 | 90 | 90 | 90 |
| Young barley grass | | 10 | | |
| powder 1 | | | | |
| Young barley grass | | | 10 | |
| powder 2 | | | | |
| Young barley grass | | | | 10 |
| powder 3 | | | | |
| Total | 100 | 100 | 100 | 100 |

Unit: % by weight

### [1-4. Test Method]

### (1-4-1. Breeding of Test Animals)

Male ICR mice (Kyudo Company) of 4 weeks-old were acclimated for 6 days. As breeding environment, lighting hours were 12 hours, and as cage, a polycarbonate flat-bottom cage (W220×D320×H135 mm; TOYORIKO) using woodchips (soft chips: Japan SLLC, Inc.) for bedding, or a stainless-steel five-chamber cage (W150×D210×H150 mm; Tokiwa Corporation) was used. Number of accommodated animals was 2 to 3 animals per cage for the flat-bottom cage, and 1 animal per chamber for the five-chamber cage. The five-chamber cage was used for collecting feces.

During the acclimation period, the feeding method was in principle free intake. As feed, MF solid feed (Oriental Yeast Co., Ltd.) was used, and for drinking water, tap water was used. After the termination of the acclimation period, heathy test animals were divided into 4 groups (6 animals per group) and subjected to test.

For the 5 weeks-old test animals divided into groups after the termination of the acclimation period, from the test start date (day 0), the animals were allowed to freely intake each test substance for 14 days. As breeding environment, lighting hours were 12 hours, and as cage, a stainless-steel five-chamber cage using woodchips (soft chips: Japan SLC, Inc.) for bedding was used. Number of accommodated animals was 1 animal per chamber. As feeder, for ease of measuring feed consumption, Roden CAFE (Oriental Yeast Co., Ltd.) was used.

Feces were collected at each measurement date, on day 12-14 after starting the test. Feces collected at day 12 and day 13 were cryopreserved at −30° C., and were used as a sample for analyzing fecal IgA level and intestinal flora.

### (1-4-2. Measurement of Fecal Wet Weight, Fecal IgA Level and Intestinal Flora)

Fecal wet weight, fecal IgA level and intestinal flora were measured by the following method.

### (A) Assessment of Fecal Wet Weight

For feces collected at 24 hours on day 14 after starting the test, fecal wet weight was measured. Larger fecal wet weight shows that the effect of ameliorating bowel movement is excellent.

### (B) Assessment of Fecal IgA Level

Fecal IgA level was measured by using Quantitative ELISA kit (Bethyl Laboratories, Montgomery, TX). Specifically, feces at day 13-14 of the test were collected, and after drying overnight at room temperature by putting on a plastic tray, they were cryopreserved at −30° C. Then, cryopreserved feces were dried for 2 days under room temperature by using a suction pump and a desiccator. Then, by using a mortar and a muddler, dried feces were crushed. Then, 1 mL PBS was added per 0.1 g of crushed feces, and extracted at room temperature for 1 hour. Then, by centrifugating for removing solid parts, feces extraction liquid was obtained. By using this feces extraction liquid, fecal IgA level was quantified with the above-mentioned Quantitative ELISA kit.

### (C) Assessment of Intestinal Flora

Intestinal flora was analyzed by real-time PCR as follows. Specifically, feces at day 13-14 of the test were collected, and after drying overnight at room temperature by putting on a plastic tray, they were cryopreserved at −30° C. Then, after supplying cryopreserved feces to a lyophilizer, crushing was performed. 100 mg per sample was measured, and extraction was performed by following the instructions of DNA extraction kit (QIA amp (registered trademark) DNA Stool Mini Kit; QIAGEN). DNA solution was diluted 50-fold with injection water to make a template.

For the above template, by following the instructions of Real-time PCR kit (QuantiNova SYBR Green master mix; Qiagen), using RoterGene Q (registered trademark; Qiagen), real-time PCR assay was performed (pre-incubation 95° C., 5 min; PCR cycle 95° C., 5 sec 60° C., 10 sec×40 cycles). Subjects of analysis were total bacteria, genus Lactobacillus, genus Prevotella and Clostridium cluster XIVa. Primer sequences listed in the following Table 4 were used.

TABLE 4

| | Type of | | SEQ ID |
|---|---|---|---|
| Name of bacteria | primer | Sequence | No. |
| Total bacteria | forward | TCCTACGGGAGGCAGCAGT | 1 |
| | reverse | GGACTACCAGGGTATCTATCCTGTT | 2 |
| Genus Lactobacillus | forward | AGCAGTAGGGAATCTTCCA | 3 |
| | reverse | ATTTCACCGCTACACATG | 4 |
| Genus Prevotella | forward | CACRGTAAACGATGGATGCC | 5 |
| | reverse | GGTCGGGTTGCAGACC | 6 |
| Clostridium clustar XIVa | forward | AAATGACGGTACCTGACTAA | 7 |
| | reverse | CTTTGAGTTTCATTCTTGCGAA | 8 |

For intestinal flora, control was used as a standard, and it was measured as a relative level with respect to the control.

### [1-5. Results]

The measurement results of fecal wet weight (average value) are shown in Table 5, measurement results of fecal IgA level (average value) are shown in Table 6, and measurement results of intestinal flora (average value of relative value with respect to control group) are shown in Table 7.

TABLE 5

| | Control group | Example 1 | Example 2 | Example 3 |
|---|---|---|---|---|
| Fecal wet weight (g) | 0.52 | 1.25 | 1.10 | 0.96 |

TABLE 6

| | Control group | Example 1 | Example 2 | Example 3 |
|---|---|---|---|---|
| Fecal IgA level | 0.80 | 25 | 2.60 | 2.59 |
| (mg-IgA/day) | | | | |

TABLE 7

| | Control group | Example 1 | Example 2 | Example 3 |
|---|---|---|---|---|
| Lactobacillus | 1 | 3.01 | 2.44 | 2.22 |
| Prevotella | 1 | 8039 | 5639 | 4998 |
| Clostridium | 1 | 3.03 | 2.46 | 2.23 |
| clustar XIVa | | | | |

For Examples 1-3, the levels of fecal wet weight, intestinal flora, and fecal IgA level were all superior with respect to control group. Therefore, it has been confirmed that by intaking young barley grass powder of the present invention, an effect of intestinal regulation, and an effect of improving maintenance of immune function are exerted. Further, smaller is the median diameter, the tendency that the effect of intestinal regulation and the effect of improving maintenance of immune function being further excellent was confirmed. In Example 1, the most excellent effect of intestinal regulation, and effect of improving maintenance of immune function were exerted.

### 2. Validation of Effects Caused by the Difference of Hemicellulose Content

The influence of hemicellulose content in young barley grass powder on the effect of intestinal regulation was assessed by performing the tests described in the following.

### [2-1. Preparation of Young Barley Grass Powder]

For 5 barleys which cultivation place or cultivation period is different, young barley grass comprising young leaves and stem which are aerial parts of barley was harvested when the height reached about 30 cm, and cut after being washed with water, to perform pre-treatment. The pretreated young barley grass was subjected to blanching treatment, then cooled with cold water, and then subjected to drying treatment, coarse crushing treatment, and fine crushing treatment so that the median diameters have comparable levels (about 13 μm), to prepare young barley grass powders A-E.

### [2-2. Measurement of Hemicellulose Content in Young Barley Grass Powder]

For young barley grass powders A-E, the content of hemicellulose in young barley grass powder was measured by Southgate method. The measurement results are shown in Table 8.

TABLE 8

| | Young barley grass powder | | | | |
|---|---|---|---|---|---|
| | A | B | C | D | E |
| Hemicellulose content (% by weight) | 14.7 | 15.9 | 16.7 | 19.4 | 19.8 |

### [2-3. Preparation of Test Substance]

Young barley grass powders A-E, casein, and MF solid feed (Oriental Yeast Co., Ltd.) were mixed, to prepare test substances shown in Table 9. Casein is an ingredient that does not affect intestinal regulation.

TABLE 9

| | Exam- | Exam- | Exam- | Exam- | Exam- |
|---|---|---|---|---|---|
| Test substance | ple 4 | ple 5 | ple 6 | ple 7 | ple 8 |
| MF solid feed | 90 | 90 | 90 | 90 | 90 |
| Young barley grass | 9.24 | | | | |
| powder A | | | | | |
| Young barley grass | | 10 | | | |
| powder B | | | | | |
| Young barley grass | | | 9.13 | | |
| powder C | | | | | |
| Young barley grass | | | | 8.73 | |
| powder D | | | | | |
| Young barley grass | | | | | 8.84 |
| powder E | | | | | |
| Casein | 0.76 | 0 | 0.87 | 1.27 | 1.16 |
| Total | 100 | 100 | 100 | 100 | 100 |

Unit: % by weight

### [2-4. Test Method]

Male ICR strain mice (7 weeks-old; Japan SLLC, Inc.) were acclimated for 5 days, and subject to test. During the acclimation period, mice were allowed to freely intake MK powder feed (Oriental Yeast Co., Ltd.). Then, mice were divided into 5 groups (6 mice per group), to start the test. During the test period, mice in each group were allowed to freely intake test substances. During 24 hours of day 7 after initiating the test, fecal wet weight and number of feces piece were measured.

### [2-5. Results]

Test results are shown in Table 10 (values are average values).

TABLE 10

| | Exam- | Exam- | Exam- | Exam- | Exam- |
|---|---|---|---|---|---|
| | ple 4 | ple 5 | ple 6 | ple 7 | ple 8 |
| Number of feces piece | 121 | 133 | 138 | 137 | 121 |
| (number of pieces) | | | | | |
| Fecal wet weight (g) | 1.95 | 2.09 | 2.28 | 2.14 | 1.90 |

As shown in Table 10, in all of Examples 4-8 in which young barley grass powders A-E which hemicellulose content is 5 to 30% by weight were administered, effect of intestinal regulation was observed.

### 3. Production of Granulated Product for Beverage

Granulated products for beverage of Examples 9 to 20 were produced by fluidized-bed granulation. Specifically, after mixing raw materials shown in Table 11, to raw materials that have been in a fluidized state, water was sprayed. Then, by drying with hot air, granulated products for beverage of Examples 9 to 20 were produced. The produced granulated products were filled in aluminum pouch, so that it is 5 g per sachets. Granulated products for beverage of Examples 9 to 20 had good fluidity and were easily filled. Granulated products for beverage of Examples 9 to 20 can be drunk as beverage, for example by being dispersed in 100 to 150 mL of water. Granulated products for beverage of Examples 9 to 20 had good dispersibility to water, and since it can be dispersed uniformly with a little stirring, it was easy to drink. By continuously intaking the granulated products for beverage of Examples 9 to 20, an effect of intestinal regulation and effect of improving maintenance of immune function are exerted.

TABLE 11

| | Example | | | | | | | | | | | |
|---|---|---|---|---|---|---|---|---|---|---|---|---|
| | 9 | 10 | 11 | 12 | 13 | 14 | 15 | 16 | 17 | 18 | 19 | 20 |
| Young barley grass powder | 100 | | | | | | 25 | | | | | |
| (median diameter 100 μm) | | | | | | | | | | | | |
| Young barley grass powder | | 100 | | | | | | 25 | | | | |
| (median diameter 50 μm) | | | | | | | | | | | | |
| Young barley grass powder | | | 100 | | | | | | 15 | | | |
| (median diameter 40 μm) | | | | | | | | | | | | |
| Young barley grass powder | | | | 100 | | | | | | 5 | | |
| (median diameter 30 μm) | | | | | | | | | | | | |
| Young barley grass powder | | | | | 100 | | | | | | 8 | |
| (median diameter 20 μm) | | | | | | | | | | | | |
| Young barley grass powder (median | | | | | | 100 | | | | | | 20 |
| diameter 10 μm) | | | | | | | | | | | | |
| Reduced oligosaccharide | | | | | | | 55 | 55 | 65 | 75 | 72 | 60 |
| Sucrose | | | | | | | 20 | 20 | 20 | 20 | 20 | 20 |
| Total | 100 | 100 | 100 | 100 | 100 | 100 | 100 | 100 | 100 | 100 | 100 | 100 |

Unit: % by weight Hemicellulose content in young barley grass powder is 17% by weight.

### INDUSTRIAL APPLICABILITY

Since young barley grass powder and the granulated product comprising young barley grass powder of the present invention exert excellent effect of intestinal regulation, and/or effect of improving maintenance of immune function, their industrial applicability is high.

What it claimed:

1. A young barley grass powder having a median diameter of 100 μm or less.

2. The young barley grass powder according to claim 1, wherein a hemicellulose content in the young barley grass powder is 5 to 30% by weight.

3. A food or beverage comprising the young barley grass powder according to claim 1.

4. A granulated product comprising the young barley grass powder according to claim 1.

5. The granulated product according to claim 4, wherein the granulated product is for beverage.

6. A food or beverage comprising the granulated product according to claim 4.

7. A granulated product comprising the young barley grass powder according to claim 2.


SEQUENCE LISTING (8 sequences)

SEQ ID NO: 1 - DNA, 19 bp, synthetic construct
  misc_feature 1..19: note = Primer
  source 1..19: mol_type = other DNA
tcctacgggaggcagcagt

SEQ ID NO: 2 - DNA, 25 bp, synthetic construct
  misc_feature 1..25: note = Primer
  source 1..25: mol_type = other DNA
ggactaccagggtatctatcctgtt

SEQ ID NO: 3 - DNA, 19 bp, synthetic construct
  misc_feature 1..19: note = Primer
  source 1..19: mol_type = other DNA
agcagtagggaatcttcca

SEQ ID NO: 4 - DNA, 18 bp, synthetic construct
  misc_feature 1..18: note = Primer
  source 1..18: mol_type = other DNA
atttcaccgctacacatg

SEQ ID NO: 5 - DNA, 20 bp, synthetic construct
  misc_feature 1..20: note = Primer
  source 1..20: mol_type = other DNA
cacrgtaaacgatggatgcc

SEQ ID NO: 6 - DNA, 16 bp, synthetic construct
  misc_feature 1..16: note = Primer
  source 1..16: mol_type = other DNA
ggtcgggttgcagacc

SEQ ID NO: 7 - DNA, 20 bp, synthetic construct
  misc_feature 1..20: note = Primer
  source 1..20: mol_type = other DNA
aaatgacggtacctgactaa

SEQ ID NO: 8 - DNA, 22 bp, synthetic construct
  misc_feature 1..22: note = Primer
  source 1..22: mol_type = other DNA
ctttgagtttcattcttgcgaa